(19) United States
(12) Patent Application Publication
(10) Pub. No.: US 2012/0062625 A1
(43) Pub. Date: Mar. 15, 2012

(54) PROJECTION APPARATUS, PROJECTION METHOD, AND PROGRAM STORAGE MEDIUM

(75) Inventors: Takeo ISHIZU, Higashimurayama-shi (JP); Hiromichi Hamada, Ome-shi (JP)

(73) Assignee: CASIO COMPUTER CO., LTD., Tokyo (JP)

(21) Appl. No.: 13/231,085

(22) Filed: Sep. 13, 2011

(30) Foreign Application Priority Data
Sep. 14, 2010 (JP) 2010-205861

(51) Int. Cl. G09G 5/10

(52) U.S. Cl. 345/691

(57) ABSTRACT

A projection apparatus includes a storage unit configured to store an image signal input via the input unit, a comparison unit configured to compare an image signal input via the input unit with an image signal already stored in the storage unit and determine one of coincidence and inconsistency between the compared two image signals, a time-measurement unit configured to measure a time of a state in which coincidence between the compared two image signals is determined by the comparison unit, a determining unit configured to determine whether or not a time-measurement result by the time-measurement unit exceeds a preset time, and a projection control unit configured to variably set the light-emission luminance of the light source to be lowered according to a determination result of the determining unit.

### CROSS-REFERENCE TO RELATED APPLICATIONS

This application is based upon and claims the benefit of priority from prior Japanese Patent Application No. 2010-205861, filed Sep. 14, 2010, the entire contents of which are incorporated herein by reference.

### BACKGROUND OF THE INVENTION

1. Field of the Invention

The present invention relates to a projection apparatus that is particularly suitably used for a battery-driven data projector whose power consumption is limited, a projection method, and a program storage medium.

2. Description of the Related Art

For example, in Jpn. Pat. Appln. KOKAI Publication No. 2007-334092, the technique for detecting the presence or absence of an image signal and lowering the luminance of an LED light source by PWM control when detecting that inputting of the image signal is interrupted in the course of projection of an image according to an input pixel signal is considered to provide a projector that can suppress power consumption without degrading the usability thereof.

The technique described in the above specification detects the state in which i of the image signal is interrupted and controls the luminance of the light source to be lowered. Therefore, in a state in which the image signal is successively input, projection is successively performed with the constant luminance irrespective of the content of the image.

However, various states in which no problem occurs in an image-viewing environment even when the luminance is lowered can he considered, depending on a projection environment. In such a case, electric power will be wastefully consumed if a normal projection operation is successively performed without lowering the luminance.

### BRIEF SUMMARY OF THE INVENTION

Accordingly, it is an object of the invention to provide a projection apparatus, a projection method and a program storage medium, capable of finely controlling the projection luminance as required even in a projection environment in which an image signal is input and more effectively suppressing power consumption.

According to one aspect of the present invention, there is provided a projection apparatus comprising: an input unit configured to input an image signal; a light source configured to variably set a light-emission luminance; a projection unit configured to form an optical image corresponding to an image signal by using light from the light source and project the same; a storage unit configured to store an image signal input via the input unit; a comparison unit configured to compare an image signal input via the input unit with an image signal already stored in the storage unit and determine one of coincidence and inconsistency between the compared two image signals; a time-measurement unit configured to measure a time of a state in which coincidence between the compared two image signals is determined by the comparison unit; a determining unit configured to determine whether or not a time-measurement result by the time-measurement unit exceeds a preset time; and a projection control unit configured to variably set the light-emission luminance of the light source to be lowered according to a determination result of the determining unit.

According to another aspect of the present invention, there is provided a projection method for use in an apparatus that includes an input unit configured to input an image signal, a light source configured to variably set light-emission luminance and a projection unit configured to form an optical image corresponding to an image signal, the projection method comprising: storing an image signal input via the input unit; comparing an image signal input via the input unit with an image signal already stored in the storage unit and determining one of coincidence and inconsistency between the compared two image signals; measuring a time of a state in which coincidence between the two image signals is determined by the comparison; determining whether or not a time-measurement result by the time-measuring exceeds a preset time; and performing a projection control operation to variably set the light-emission luminance of the light source to be lowered according to a determination result by the determination.

According to still another aspect of the present invention, there is provided a non-transitory computer-readable storage medium having program code stored thereon for controlling an image composition apparatus including an input unit configured to input an image signal, a light source configured to variably set light-emission luminance and a projection unit configured to form an optical image corresponding to an image signal by use of light from the light source and project the same, the program code comprising: storing an image signal input via the input unit; comparing an image signal input via the input unit with an image signal already stored in the storage unit and determining one of coincidence and inconsistency between the compared two image signals; measuring a time of a state in which coincidence between the two image signals is determined by the comparison; determining whether or not a time-measurement result by the time-measuring exceeds a preset time; and performing a projection control operation to variably set the light-emission luminance of the light source to he lowered according to a determination result by the determination.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a function circuit of a data projector apparatus according to one embodiment of the invention;

FIG. 2 is a flowchart for illustrating the processing content of a projection operation after the power source is turned on in the present embodiment; and

FIG. 3 is a diagram showing the control characteristic of light-emission luminance of a light source according to the present embodiment.

### DETAILED DESCRIPTION OF THE INVENTION

There will now be explained a preferable embodiment embodying the present invention with reference to the drawings. However, in the embodiment described below, various restrictions that are technically preferable In embodying the invention are attached, but the scope of the invention is not limited to the following embodiment and an example shown in the drawing.

Now, one embodiment in which the invention is applied to a battery-driven data projector apparatus of a DLP (Digital Light Processing) (registered trademark) system is explained with reference to the drawings.

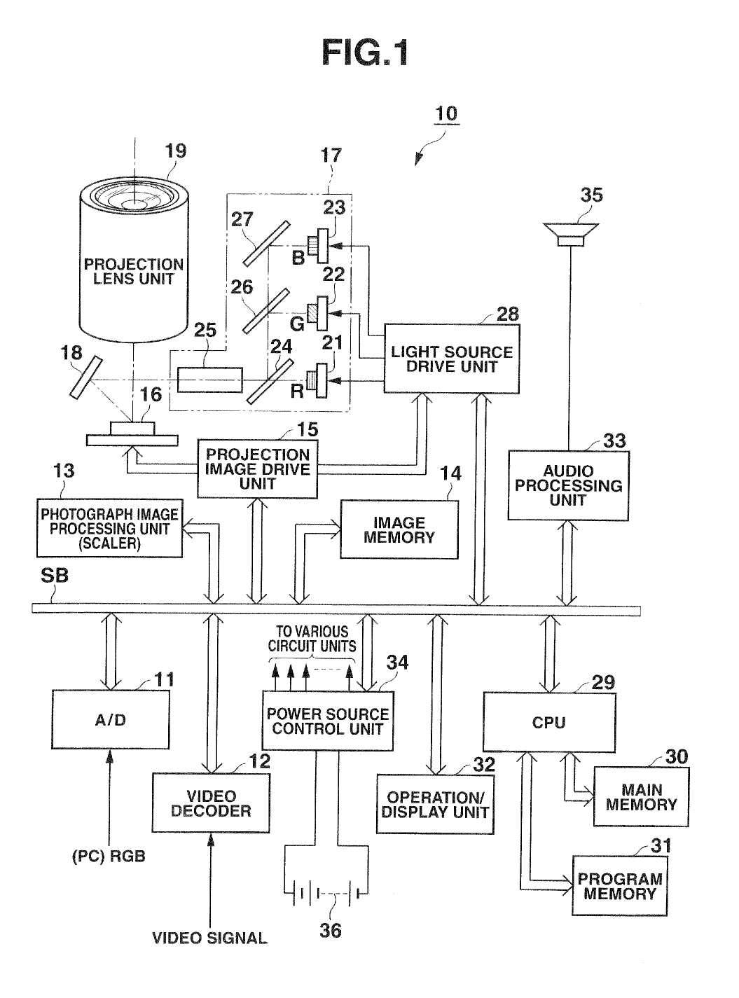

FIG. 1 is a block diagram showing the schematic configuration of a function circuit of a data projector apparatus 10 according to this embodiment. The data projector apparatus 10 includes an A/D converter 11 and video decoder 12 as an input unit.

The A/D converter 11 converts an analog ROB signal input from a personal computer or the like via an RGB input terminal of the D-sub15 type to a digital signal.

The video decoder 12 Y/C-separates an analog composite video signal input via a video input terminal of, for example, the pin jack (RCA) type and then converts the same to a digital signal.

Image data input via one of the input units 11 and 12 and converted into a digital form is supplied to a projection image-processing unit 13 via a system bus SB.

The projection image-processing unit 13 unifies input image data to image data with a preset format suitable for projection, properly writes the data in a display image memory 14, reads the written image data from the image memory 14 and supplies the road data to a projection image-processing unit 15.

At this lime, data such as symbols indicating various operation states for OSD (On Screen Display) is superimposed on the image signal in the image memory 14 by the projection image-processing unit 13 as required. Then, the thus processed image data is read and supplied to the projection image-processing unit 15.

The projection image-processing unit 15 has a capacity for storing image data of at least two frames and one of image data freely input from the input units 11 and 12, and image data held by an instruction of a CPU 29, described later, is read and supplied to the projection image-processing unit 15.

The projection image-processing unit 15 drives the display operation of a micro-mirror element 16 that is a spatial light modulation element (SLM) by a higher-speed time-divisional driving operation obtained by multiplying a frame rate according to a preset format, for example, 60 [frames/sec] and the division number of color components and the number of display gradients according to a supplied image signal.

The micro-mirror element 16 performs the display operation by rapidly turning on/off the individual inclination angles of a plurality of infinitesimal mirrors, for example, WXGA (Wide eXtended Graphic Array) (1280 pixels in width×800 pixels in length) arranged in an array form and forms an optical image based on the reflected light.

Primary-color lights of R, G and B are time-divisionally cyclically emitted from a light source unit 17. Primary-color lights from the light source unit 17 are fully reflected from a mirror 18 and applied to the micro-mirror element 16.

Then, an optical image is formed based on the reflected light from the micro-mirror element 16 and the thus formed optical image is projected to and displayed on a to-be-projected screen (not shown) via a projection lens unit 12.

The light source unit 17 includes a light-emitting diode (that is hereinafter referred to as “R-LED”) 21 that emits red (R) light, a light-emitting diode (that is hereinafter referred to as “G-LED”) 22 that emits green (G) light and a light-emitting diode (that is hereinafter referred to as “B-LED”) 23 that emits blue (B) light.

Red light emitted from the R-LED 21 passes through a dichroic mirror 24 and is supplied to the mirror 18 after obtaining a light flux whose luminance distribution is made substantially uniform by an integrator 25.

Green light emitted from the G-LED 72 is reflected from a dichroic mirror 26, then reflected from the dichroic mirror 24 and supplied to the mirror 18 via the integrator 25.

Blue light emitted from the B-LED 23 is first reflected from a mirror 27, passes through the dichroic mirror 26, is then reflected from the dichroic mirror 24 and is supplied to the mirror 18 via the integrator 25. The dichroic mirror 24 passes red light and reflects green light and blue light. The dichroic mirror 26 reflects green light and passes blue light.

The waveforms of the drive signals and the light-emission timings of the respective LEDs 21 to 23 of the light source unit 17 are integrally controlled by a light source drive unit 28. The light source drive unit 28 controls the timing of image data supplied from the projection image-processing unit 15 and the light-emitting operations of the LEDs 21 to 23 under control of the CPU 29 that will be described later.

The CPU 29 controls all of the operations of the respective circuits. The CPU 29 is directly connected to a main memory 30 and program memory 31. The main memory 30 is configured by a DRAM and functions as a work memory of the CPU 29. The program memory 31 is configured by an electrically erasable and programmable nonvolatile memory and stores various fixed data items such as image data of a menu screen, described later, and an operation program executed by the CPU 29.

The CPU 29 reads operation program data or the like stored in the program memory 31, develops the same on the main memory 30, stores the result therein and executes the program to generally control the data projector apparatus 10.

The CPU 29 performs various projection operations in response to a key operation signal from an operation/display unit 32. The operation/display unit 32 includes a key operation unit and indicator unit provided on the main body of the data projector apparatus 10 and a laser light-receiving unit that receives red light from a remote controller (not shown) exclusive for the data projector apparatus 10. The operation/display unit 32 outputs a key signal generated based on a key operated by the user by means of the key operation unit of the main body or remote controller to the CPU 29.

Specifically, a power source key, input switching key, focus·up/down key, zoom·up/down key, menu key, cursor (“↑”, “↓”, “←”, “→”) keys, set key, cancel key and the like are provided on the key operation unit of the main body or remote controller.

The CPU 29 is further connected to an audio processing unit 33 and power source control unit 34 via the system bus B. The audio processing unit 33 includes a sound source circuit such as a PCM sound source, converts audio data given at the projection. operation time to an analog signal, and drives a speaker unit 35 to generate an amplified sound, beep sound or the like as required.

The power source control unit 34 converts the electric power supplied from a charging battery 36 that is a power source of the main apparatus 10 to voltages required for the respective circuits, supplies the voltages to the respective circuits and reports the remaining capacity based on the terminal voltage of the charging battery 36 in response to a request from the CPU 29.

Next, the operation of this embodiment is explained. As described above, the projection image-processing unit 13 forms an image to be displayed on the micro-mirror element 16 by use of the image memory 14, the projection image-processing unit 15 displays the thus formed image on the micro-mirror element 16 and the light source drive unit 28 drives the LEDs 21 to 23 to emit light according to display on the micro-mirror element 16.

The projection image-processing unit 13, image memory 14, projection image-processing unit 15 and light source drive unit 28 are operated under control of the CPU 29. The CPU 29 reads an operation program, fixed data and the like stored in the program memory 31 including the process described below, develops the data on the main memory 30 and performs a control process.

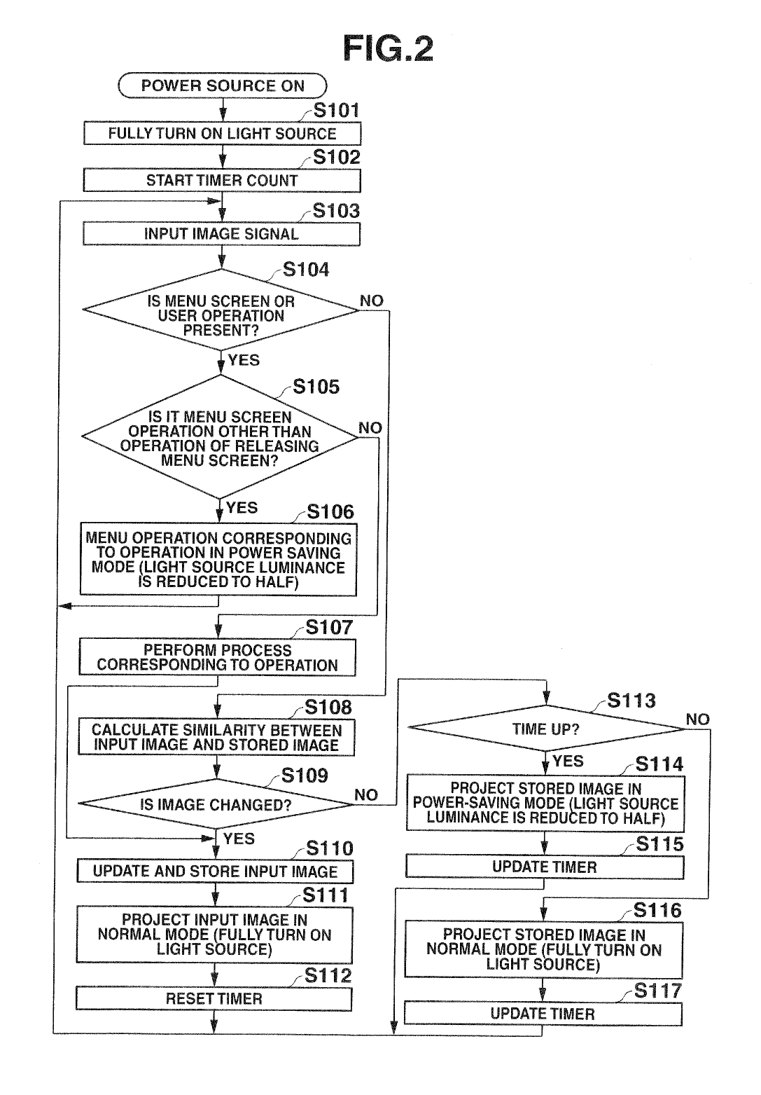

FIG. 2 shows the processing content mainly related to the light source luminance control operation at the projection operation time performed immediately after the power source is turned on.

The CPU 29 causes the light source drive unit 28 to drive the LEDs 21 to 23 of the light source unit 17 with currents to attain the luminance of 100% of the rating at the initial time of the process (step S101).

At this time, the CPU 29 starts the count operation of a timer register set in the main memory 30 (step S102). The timer register measures the time during which no variation is observed in a projected image or the time that has elapsed after the key operation was last performed. by the user on the operation/display unit 32 in an operation environment in which the light source unit 17 is driven for lighting with the rated luminance.

After this, an image signal is input via the A/D converter 11 or video decoder 12 and converted. into a. digital signal and the thus obtained image data is stored in the image memory 14 by the projection image-processing unit 13 (step S103).

At this time, the CPU 29 determines whether or not a menu screen based on the image data read from the program memory 31 is being projected instead of input image data. or an operation by the user is performed by the operation/display unit 32 (step S104).

If it is determined that the menu screen is not being projected and the operation by the operation/display unit 32 is net performed, the similarity between the input image data and image data for comparison already stored in the projection image-processing unit 15 at this time is calculated (step S108).

At the similarity calculation time, for example, the correlation between data items in the same pixel positions configuring the image data items is derived and the percentage of the number of pixels that are coincident in the whole frame is calculated.

Whether or not a variation occurs in the input image signal is determined according to whether or not the thus calculated similarity is less than a preset threshold value (step S109). In this case, the reason why a variation in the image is determined based on the calculated similarity is to consider a possibility that an error occurs at the time of A/D conversion in the A/D converter 11 or video decoder 12 even if the image signal input to the A/D converter 11 or video decoder 12 is a still image and the content thereof is kept unchanged and the same data may be converted to a digital signal as data items that are different in the preceding frame and the next frame. An error in A/D conversion can be permitted and a variation in the image can be correctly determined by thus previously setting the threshold value for similarity determination to cope with an error in A/D conversion.

If image data for comparison is not yet stored in the projection image-processing unit 15 immediately after the power source is turned on, the similarity between two image data items becomes “0 (zero) %” and it is determined that the image is varied.

If it is determined in step S109 that the image is changed, input image data is newly stored as image data for comparison in the projection image-processing unit 15 (step S110) and projection based on input image data is performed in the normal light-emission luminance mode, that is, by driving the LEDs 21 to 23 of the light source unit 17 with the rated currents (step S111).

Additionally, after the measurement time of the timer register set in the main memory 30 is reset (step S112), the process is returned to step S103 to prepare for inputting of a next image signal.

Further, if it is determined in step S109 that the similarity is not less than the preset threshold value and no change occurs in the input image signal, whether or not an image that is kept unchanged is successively input for more than a preset period is determined (step S113) according to whether or not a value of the timer register of the audio processing unit 33 at this time has reached a preset time value, for example, “10 minutes”.

If it is determined that a value of the timer register has not reached the preset time value and the input time of an image that is kept unchanged has not reached a preset period, projection based on image data stored for comparison is performed in the normal light-emission luminance mode, that is, by driving the LEDs 21 to 23 of the light source unit 17 with the rated currents (step S116).

Additionally, after the measurement time of the timer register set in the main memory 30 is updated and set (step S117), the process is returned to step S103 to prepare for inputting of a next image signal.

The reason why projection is performed based not on input image data but on image data stored for comparison in step S116 is to prevent fine fluctuation from occurring in a projected image due to an error in A/D conversion when it is determined that the input image is kept unchanged.

Further, if it is determined in step S113 that a value of the timer register has reached the preset time value and the input time of an image that is kept unchanged has reached a preset period, projection bused on image data stored for comparison is performed in the power-saving mode instead of the normal light-emission luminance mode, for example, by adjusting currents to set the light-emission luminance of the LEDs 21 to 23 of the light, source unit 17 to 50% of the rating and driving the LEDs (step S114).

Additionally, after the measurement time of the timer register set in the main memory 30 is updated and set (step S115), the process is returned to step S103 to prepare for inputting of a next image signal.

The reason why projection is performed based riot on input image data but on image data stored for comparison in step S114 is to prevent fine fluctuation from occurring in a projected image due to an error in A/D conversion when it is determined that the input image is kept unchanged, like the case of step S116.

Further, if it is determined in step S104 that a menu screen is being projected or an operation by the operation/display unit 32 is performed, it is determined whether or not the operation is related to any operation performed on the menu screen except the operation for releasing the menu screen (step S105).

When it is determined that the operation is related to any operation performed on the menu screen, currents are adjusted to set the light-emission luminance of the LEDs 21 to 23 of the light source unit 17 to 50% of the rating and drive the LEDs in the power-saving mode instead of the normal light-emission luminance mode and the operation process and projection corresponding to the above operation on the menu screen are performed (step S106). Then, the process is returned to step S103 to prepare for inputting of a next image signal.

If it is determined in step S105 that the operation for releasing the menu screen or the operation other than the operation on the menu screen is performed, a process based on the content of the operation is performed (step S107).

After this, the process proceeds to step S110 and input image data is newly restored as image data for comparison in the projection image-processing unit 15. Then, projection based on input image data is performed in the normal light-emission luminance mode, that is, by driving the LEDs 21 to 23 of the light source unit 17 with the rated currents (step Sill).

Additionally, after the measurement time of the timer register set in the main memory 30 is reset (step S112), the process is returned to step S103 to prepare for inputting of a next image signal.

As described above in detail, according to this embodiment, a case wherein no problem seems to occur even if the luminance is lowered is determined when the content of the image is kept unchanged for a preset time or more in the projection environment in which the image signal is input. Further, power consumption can be more effectively suppressed by finely controlling the projection luminance as required, and the apparatus driven by the battery power source whose power amount is limited is particularly suitably used.

In the above embodiment, a case wherein the light-emission luminance of the LEDs 21 to 23 of the light source unit 17 is controlled to be set in one of the two stages of the normal light-emission mode and the power-saving mode in which the luminance is lowered to 50% is explained. However, the control operation is not performed in one of the two stages but may be performed in one of more finely divided stages.

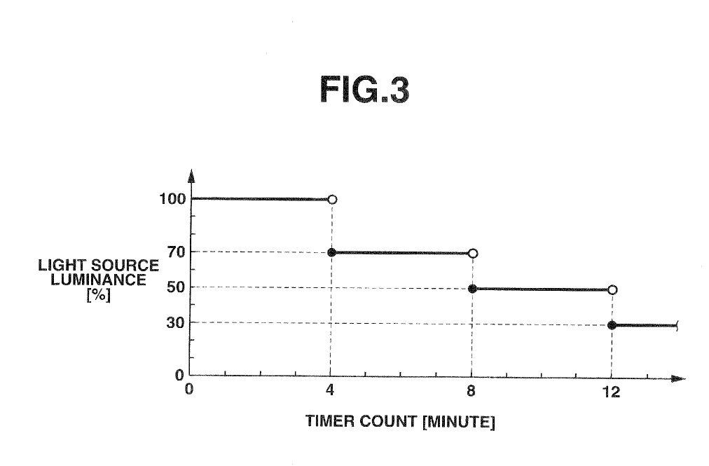

FIG. 3 is a diagram for illustrating a case wherein the light-emission luminance of the LEDs 21 to 23 of the light source unit 17 is controlled in four separate stages. In the drawing, an input image is kept unchanged and the relationship between a value of the timer register used for measuring the time in which the operation in the operation/display unit 32 is not performed and the light-emission luminance to be controlled is shown.

In this example, the light-emission luminance can be variably set to four stages of “10% (rating)”, “70%”, “50%” and “30%” according to four time ranges of “0 (zero) minutes to less than 4 minutes”, “4 minutes to less than 8 minutes”, “8 minutes to less than 12 minutes” and “12 minutes or more” based on the value of the timer register.

Since the light-emission. luminance of the LEDs 21 to 21 of the light source unit 17 is more finely controlled by thus setting a plurality of time ranges used as the control reference, the luminance can be lowered without giving an unnatural feeling to a person who watches the projection image and wasteful power consumption can be avoided by gradually lowering the brightness of the projection content.

Further, in the above embodiment, not only in a case where an input image is changed but also in a case wherein any operation is performed by the user of the apparatus 10 by the operation/display unit 32, the content of the time register is reset.

As a result, in a state wherein any operation is performed although the image itself to be projected is kept unchanged and it is considered that the user closely observes the content of a projection image, the control operation is performed not to easily lower the light-emission luminance and the usability on the user side can be prevented from being degraded.

In the above embodiment, when whether or not the image is changed is determined, the similarity between the input image and the already stored image is calculated and the presence or absence of a change in the image is determined based on the calculation result.

As a result, even when the input image signal is required to be subjected to A/D conversion, an influence of an error of A/D conversion can be eliminated and the presence or absence of a change in the image can be adequately determined.

Further, in the above embodiment, projection is performed by using the image stored for comparison instead of an input image while it is determined that the image is kept unchanged. Therefore, a stable image that can be easily observed can be projected without causing fine “fluctuation” due to an error or the like of the A/D conversion.

Further, in the above embodiment, the light-emission luminance of the LEDs 21 to 23 of the light source unit 17 is uniformly lowered in a state wherein the menu screen is projected instead of the input image signal. As a result, power consumption can be reduced without fail in the menu screen in which particularly fine image representation or the like seems not to be provided.

In the above embodiment, a case wherein the apparatus is applied to a data projector apparatus in which the LED that is a semiconductor light source element is used as a light source and the battery is used as the power source is explained. However, in the invention, the type of the power source and the element used as the light source are not limited.

In addition, the invention is not limited to the above embodiment and is variously modified without departing from the scope thereof at the embodying stage. Further, the functions realized by the above embodiment can be adequately combined as far as possible and performed. The above embodiment contains various stages and various inventions can be extracted. by adequately combining a plurality of constituents disclosed. For example, if the effect can be attained. even when some constituents are eliminated from all of the constituents shown in the embodiment, the configuration in which the constituents are eliminated. can be extracted as the invention.

Additional advantages and modifications will readily occur to those skilled in the art. Therefore, the invention in its broader aspects is not limited to the specific details and representative embodiments shown and described herein. Accordingly, various modifications may he made without departing from the spirit or scope of the general inventive concept as defined by the appended claims and their equivalents.

What is claimed is:

1. A projection apparatus comprising:
an input unit configured to input an image signal;
a light source configured to variably set a light-emission luminance;
projection unit configured to form an optical image corresponding to an image signal by using light from the light source and project the same;
a storage unit configured to store an image signal input via the input unit;
a comparison unit configured to compare an image signal input via the input unit with an image signal already stored in the storage unit and determine one of coincidence and inconsistency between the compared two image signals;
a time-measurement unit configured to measure a time of a state in which coincidence between the compared two image signals is determined by the comparison unit;
a determining unit configured to determine whether or riot a time-measurement result by the time-measurement unit exceeds a preset time; and
a projection control unit configured to variably set the light-emission luminance of the light source to be lowered according to a determination result of the determining unit.

2. The projection apparatus according to claim 1, further comprising an operation unit configured to receive an operation related to the projection operation,
wherein the time-measurement unit resets the time-measurement result when an operation is received by the operation unit.

3. The projection apparatus according to claim 1, wherein the comparison unit calculates a similarity between an image signal input via the input unit and an image signal stored. in the storage unit and determines one of coincidence and inconsistency between the two image signals according to whether or not the calculated similarity exceeds a preset threshold value.

4. The projection apparatus according to claim 1 wherein the projection unit forms an optical image according to an image signal stored in the storage unit instead of an image signal input via the input unit and projects the same when coincidence between the two image signals is determined by the comparison unit.

5. The projection apparatus according to claim 1, wherein:
the determining unit determines whether or not the time-measurement result by the time-measurement unit exceeds a plurality of preset times, and
the projection control unit variably sets the light-emission luminance of the light source to be gradually lowered according to the elapse of time based on a determination result of the determining unit.

6. The projection apparatus according to claim 1, further comprising:
a menu storage unit configured to store an image signal of a menu screen; and
an instruction unit configured to instruct projection of a menu screen stored in the menu storage unit instead of an image signal input via the input unit,
wherein the projection control unit variably sets the light-emission luminance of the light source to be lowered while the projection unit is forming an optical image according to an image signal of the menu screen and projecting the same in response to an instruction from the instruction unit.

7. A projection method for use in an apparatus that includes an input unit configured to input an image signal, a light source configured to variably set light-emission luminance and a projection unit configured to form an optical image corresponding to an image signal, the projection method comprising:
storing an image signal input via the input unit;
comparing an image signal input via the input unit with an image signal already stored in the storage unit and determining one of coincidence and inconsistency between the compared two image signals;
measuring a time of a state in which coincidence between the two image signals is determined by the comparison;
determining whether or not a time-measurement result by the time-measuring exceeds a preset time; and
performing projection control operation to variably set the light-emission luminance of the light source to be lowered according to a determination result by the determination.

8. A non-transitory computer-readable storage medium having program code stored thereon for controlling an image composition apparatus including an input unit configured to input an image signal, a light source configured to variably set light-emission luminance and a projection unit configured to form an optical image corresponding to an image signal by use of light from the light source and project the same, the program code comprising:
storing an image signal input via the input unit;
comparing an image signal input via the input unit with an image signal already stored in the storage unit and determining one of coincidence and inconsistency between the compared two image signals;
measuring a time of a state in which coincidence between the two image signals is determined by the comparison;
determining whether or not a time-measurement result by the time-measuring exceeds a preset time; and
performing a projection control operation to variably set the light-emission luminance of the light source to be lowered according to a determination result by the determination.
